(19) United States
(12) Patent Application Publication
(10) Pub. No.: US 2009/0198733 A1
(43) Pub. Date: Aug. 6, 2009

(54) HEALTHCARE RESOURCE LOCATOR

(75) Inventors: Alexander Gounares, Kirkland, WA (US); Steven Bathiche, Kirkland, WA (US); Kim Cameron, Bellevue, WA (US); Oren Rosenbloom, Redmond, WA (US); Eric J. Horvitz, Kirkland, WA (US); Kenneth D. Ray, Seattle, WA (US); Hong L. Choing, Collegeville, PA (US); Hubert Van Hoof, Seattle, WA (US); Chris Demetrios Karkanias, Sammamish, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/024,166

(22) Filed: Feb. 1, 2008

(51) Int. Cl. G06F 17/00

(52) U.S. Cl. 707/104.1; 707/E17.001

(57) ABSTRACT

The claimed subject matter provides a system and/or a method that facilitates identifying a medical facility for an emergency medical situation. An interface can receive a portion of data related to an emergency medical incident and a corresponding location. A match component can evaluate the portion of data to select a medical facility in which to transport a patient involved in the emergency medical incident, wherein the medical facility can be ascertained based on a distance between the location of the emergency medical incident and a location for the selected medical facility and traffic related to a route there between.

### BACKGROUND

Microprocessor-based devices have evolved into reliable and pervasive tools that facilitate everyday common tasks (e.g., microwave cooking, automobile ignition systems, entertainment centers . . . ), complex mathematical computations (e.g., trending, controlling a robot, forecasting . . . ), sophisticated applications (e.g., business workflow, word-processing, financial logging, electronic mail . . . ), etc. Such devices typically include one or more processors and various types of memory as well as other components that enable efficient and robust multi-tasking. Incremental advances in electronics, networking and software technologies have resulted in reduced device production costs that have correlated to decreased consumer purchasing costs, which has rendered computers (e.g., desktop, laptop, handheld . . . ) essentially ubiquitous throughout many portions of the world.

As computing devices have become more widespread, migration to various fields such as medicine have been rising. More often than not, the need for medical care does not occur within close proximity of a medical facility. In other words, accidents, injuries, medical emergencies, and the like often require medical transport to a medical facility. Typical medical transports vary based on the severity of the injury, the distance to the medical facility, specialists or equipment that are required for the injury, etc. For example, an injured party may be transported to a medical facility (e.g., hospital, medical center, emergency room, etc.) by various transportation modes such as ambulances, helicopters, boats, planes, snowmobiles, all-terrain vehicles, and the like. Yet, a common theme with transporting a medical emergency or injury to a medical facility is quickness. In general, utilizing computing devices and technological advances in the medicine world can provide increased efficiency, decrease errors and costs, and more importantly save lives.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate identifying an optimal medical facility to transport a patient involved in an emergency medical incident. Moreover, the subject innovation relates to systems and/or methods that facilitate routing a patent to medical care and/or routing medical care to a patient. A match component can be utilized in order to identify an optimal selection of a medical facility to transport a patient based on evaluating a portion of data related to at least one of a patient in need of emergency medical attention, a medical facility, and/or a route and respective traffic between the medical facility and the patient. In general, the match component can examine the portion of data to select a medical facility, a route or set of directions, and/or a patient needs (e.g., medical assets, specialists, etc.) based upon a patient location, traffic evaluation, a patient health condition, available medical support (e.g., devices, medicine, personnel, etc.), predicted traffic, patient authorized medical data, and/or patient status (e.g., vital signs, injury, etc.).

In addition, the match component 102 can provide routing for a patient to receive medical care and/or enable medical care to be routed to a patient. The match component can evaluate a portion of data in order to provide optimal routes or direction to direct a patient to a medical facility and/or medical care. Furthermore, the match component can evaluate a portion of data related to an accident or incident in which care can be provided to the patient. In addition, the match component can evaluate data related to an accident in order to assist with determining medical specialists or recommendations (e.g., referrals specific to incident or patient, consultations, experts, specialty leaders, etc.).

In accordance with an aspect of the claimed subject innovation, the match component can further utilize a contingency component that can generate a contingency plan during a transport of a patient to a medical facility based upon an unexpected event or circumstance. The contingency component can provide a real time adjustment to directions, routes, and/or a medical facility based on an unexpected event or circumstance that occurs during a medical transport. In other aspects of the claimed subject matter, methods are provided that facilitate matching an urgent medical situation to a medical facility based on predicted travel time and/or traffic patterns.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates identifying an optimal medical facility to transport a patient involved in an emergency medical incident.

FIG. 2 illustrates a block diagram of an exemplary system that facilitates matching an urgent medical situation to a medical facility based on predicted travel time and/or traffic patterns.

FIG. 3 illustrates a block diagram of an exemplary system that facilitates transporting a patient in need of urgent medical care to a medical facility based on evaluating an injury of the patient and/or characteristics of the potential medical facilities.

FIG. 4 illustrates a block diagram of an exemplary system that facilitates identifying an optimal medical facility for a patient in need of emergency or urgent medical attention.

FIG. 5 illustrates a block diagram of exemplary system that facilitates communicating with a plurality of medical facilities to assess an appropriate facility to transport an emergency medical incident.

FIG. 6 illustrates a block diagram of an exemplary system that facilitates employing predictive techniques to infer selection of a medical facility to receive an emergency incident.

FIG. 7 illustrates an exemplary methodology for identifying a medical facility to transport an emergency situation based on travel distance and/or traffic.

FIG. 8 illustrates an exemplary methodology that facilitates generating a contingency plan for a real time event or circumstance that occurs during transport of an emergency medical incident.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “cloud,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

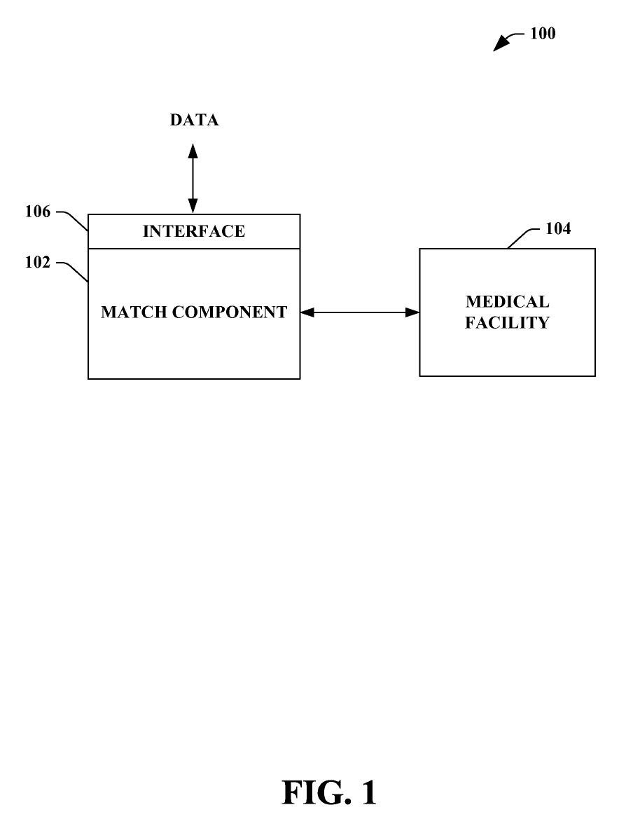

Now turning to the figures, FIG. 1 illustrates a system 100 that facilitates identifying an optimal medical facility to transport a patient involved in an emergency medical incident. Moreover, the system 100 can provide an optimal medical care solution to be transported to the patient involved in a medical emergency incident. The system 100 can include a match component 102 that can receive (via an interface component 106) a portion of data related to an emergency incident or accident involving a patient that requires medical attention, wherein the portion of data can include a location of the patient, a status of the patient, and/or medical history of the patient (e.g., personal health records, etc.). The match component 102 can evaluate the portion of data in order to identify an optimal medical facility 104 to which the patient can be transported. In general, the match component 102 can consider data related to the patient (e.g., patient data such as patient location, status, urgency, insurance coverage, patient preference, patient authorized medical data, etc.), information related to potential or available medical facilities (e.g., medical facility data such as, travel distance, routes from the patient location to the medical facility location, staffing, available resources, etc.) as well as data related to traffic (e.g., traffic data such as traffic predictions, traffic flow, emergency vehicle patterns, etc.). In other words, the match component 102 can employ traffic evaluation and/or prediction in order to generate a probable distribution of a patient needs in an emergency situation as well as facilities available in order to give the best match based on the flow of traffic (e.g., matching a patient and corresponding urgency with a medical facility 104). Moreover, the match component 102 can evaluate the portion of data in order to identify a specialist (e.g., a specialist for referral, etc.), a SME for consultation/collaboration, etc. Such information gathered and/or collected can be further implemented into a social network for doctors and/or medical professionals, wherein the match component 102 can be the engine.

The match component 102 can evaluate the portion of data (e.g., patient data, medical facility data, and/or traffic data) such as, but not limited to, traffic patterns, previous traffic flows, databases of ambulance flows, medical facility assets (e.g., devices in a vehicle/facility, drugs, equipment, needles, oxygen, scanning devices, etc.), medical professional staffing (e.g., employees on staff, specialists, experts, surgeons, credentials of employees, etc.), patient status during transport, severity of injuries, a location of patient, a location of the emergency situation, received medical data (e.g., EMT report, initial prognosis, blood pressure, vital stats, heart rate, historic medical data, etc.), history of traffic patterns, emergency vehicle routes, directions, travel distance, and/or any other suitable data associated with transporting a patient to a medical facility 104 in an emergency situation. In other words, the match component 102 can evaluate patient data, medical facility data, traffic data, and/or any suitable combination thereof in order to identify an optimal match or pairing between a patient in need of urgent or emergency care and a medical facility or service (e.g., medical person, mobile medical care unit, etc.).

For example, the match component 102 can evaluate patient authorized medical data to identify at least one of an optimal medical facility, a set of directions or route to guide a patient to a medical facility, or a medical service/care (e.g., mobile medical unit, etc.) to intercept the patient. For example, ICE (In-Case-of Emergency) services can be available allowing emergency personnel to access and see data that a patient has authorized to be made available in case of an emergency. Besides standard demographics information this can include data like medication list and history, health plan information, contacts, advanced directives, chronic conditions, medical devices (e.g., implanted), etc. In another example, the match component 102 can employ advanced directives to direct routing of the patient even when deceased (e.g., organ donation to particular patient in a specific location, etc.).

For example, the match component 102 can evaluate a portion of data related to an accident or incident that requires urgent medical care in order to identify a suitable combination for a patient (involved in the accident or incident), wherein the combination can include transportation (e.g., ambulance, helicopter, boat, air transport, etc.), directions, assets, personnel/staff, and facilities in light of a physical analysis of traffic and traffic forecast. In other words, the match component 102 can identify an optimized combination of availability, presence, and transportation, wherein estimations of time arrival, availability of resources (e.g., experts, doctors, operating rooms, medicine, devices, electronics, etc.), and/or presence (e.g., patient/doctor availability, status, etc.) are considered and factored in accordingly.

In addition, the match component 102 can further identify a portion of directions or route to a medical facility or service based at least in part upon the portion of data related to the patient, accident, incident, patient location, etc. For instance, a patient in need of medical care can be provided directions to a health care resource (e.g., a hospital, a medical facility, a health care provider, a mobile health care unit, etc.). In other words, the match component 102 can help an individual route themselves to an appropriate facility through the use of a device (e.g., cell phone, mobile PC, portable digital assistant (PDA), laptop, mobile device, etc.) in cases in which an individual is looking for emergency care but is still mobile. In particular, the match component 102 can be incorporated as a tool or a built-in diagnostic service for such device (e.g., consumer electronics, cell phone, smartphone, PDA, mobile device, gaming device, laptop, etc.). For instance, the device can connect to the cloud (e.g., discussed in more detail below) or through the PC or other hubs to further facilitate initial self-diagnosis to feed into the overall system 100.

It is to be appreciated that the match component 102 can enable optimal selection of care for an emergency accident or incident. Thus, the match component 102 can identify a medical facility, a medical person, a medical mobile unit, or a medical service for at least one of a patient, an accident, or an incident. The match component 102 can optimally identify medical services (e.g., care, facilities, personnel, etc.), wherein the services can be directed to the patient or the patient can be directed to the services. For instance, the services or caregiver can determine extra equipment he or she brings may be based on data provided and available from the incident location gathered by the match component 102 and/or the interface 106. It is to be appreciated that the data can be generated by a wide variety of sources, ambient sensor networks and devices (e.g., car sensors, car devices, accident location sensors, traffic cameras, home devices, vehicle remote monitoring services, cell phone, devices carried by a patient, etc.).

The match component 102 can further be utilized to facilitate identifying recommendations, referrals, specialists, and the like in connection with a patient involved in an accident or incident. In particular, the match component 102 can evaluate data related to the accident, the patient, an injury, etc. in order to assist in medical recommendations. For example, a medical provider such as a Primary Care Physician (PCP) can assist with determining which medical specialist a PCP should refer their patients to based on at least one of specialist specialty, proximity to both the PCP and the patient, patient's insurance coverage plan, patient preference, PCP preferences, PCP preferences based on physician scorecard ratings, past experiences, etc. Furthermore, the match component 102 can be used by doctors and/or medical professionals to identify subject matter experts (SME) in any medical specialty field for the purpose of seeking out thought leaders in their respective field for consultation. This can be between one medical professional to another. For example, a doctor in Asia can be looking for a premier surgeon for heart bypass procedure in the USA, wherein such professionals can start collaboration (e.g., dialogs, instant messaging, cellular calls, Voice Over Internet Protocol (VoIP) calls, email, instant messaging, etc.) or commence a consultation (mentoring) relationship. In other words, the match component 102 can evaluate data related to an incident and/or accident in order to initiate a communication portal for potential matched medical professionals.

Additionally, the match component 102 can enable on site medical care for a medical emergency, accident, or incident. For instance, medical instrumentation and diagnoses equipment can be integrated (e.g., lab on a chip) to allow field diagnoses and treatment to be faster, cheaper, and sometimes safer for the patient. For example, a doctor driving around in an ambulance being led to some predictive model as to where a an injury would occur in the coming future (traffic, crime, events, etc.). The system 100 can have a network balancing the load of the hospital, medical facility, mobile medical units, etc., wherein an assessment at the scene can be made weather this injury can be treated on site or in the hospital.

In addition, the system 100 can include any suitable and/or necessary interface component 106 (herein referred to as “interface 106”), which provides various adapters, connectors, channels, communication paths, etc. to integrate the match component 102 into virtually any operating and/or database system(s) and/or with one another. In addition, the interface 106 can provide various adapters, connectors, channels, communication paths, etc., that provide for interaction with the match component 102, the medical facility 104, patients in need of emergency medical care, and any other device and/or component associated with the system 100.

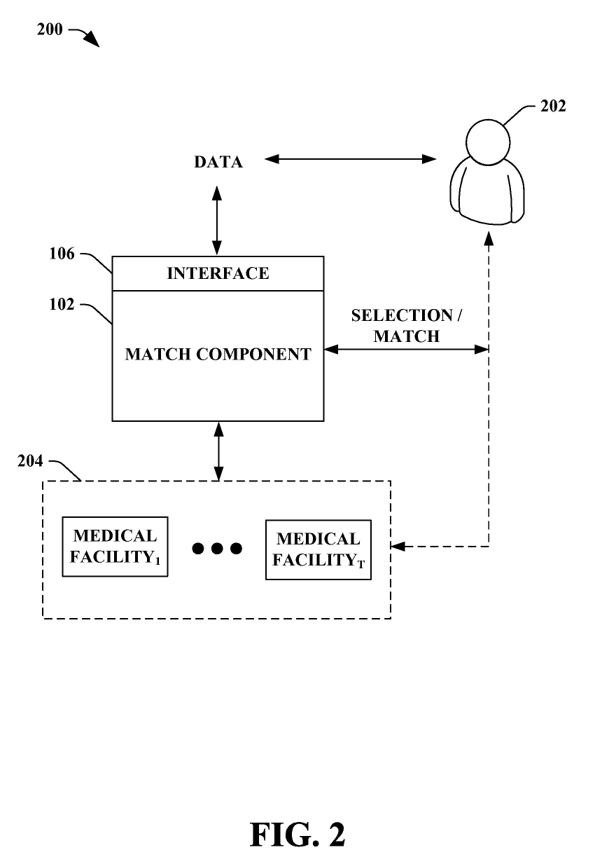

FIG. 2 illustrates a system 200 that facilitates matching an urgent medical situation to a medical facility based on predicted travel time and/or traffic patterns. The match component 102 can receive a portion of data related to a user 202, wherein the user is in need of urgent or emergency medical care. The match component 102 can evaluate and analyze the portion of data in order to select an optimal medical facility 104 from a plurality of medical facilities 204. Typically, a patient in need of urgent or emergency care is transported to the closest medical facility without any computations or predictions in order to ensure such selection is best fit for the circumstances and/or factors related to the incident or accident. Yet, the match component 102 can provide a “smart” selection of a medical facility from the plurality of medical facilities 204. It is to be appreciated that there can be any suitable number of medical facilities 204 such as medical facility₁ to medical facility_{T}, where T is a positive integer.

In particular, the match component 102 can evaluate the portion of data related to the user (e.g., the potential patient in need of medical assistance), wherein the portion of data can be, but is not limited to being, patient data, genomic profile, authorized data from relevant relatives in a genealogy tree (e.g., indicating susceptibility to certain conditions/complications, etc.), historic medical data related to the user 202, medical data related to the user 202 (e.g., injuries, vitals, medical evaluation data from on-site emergency medical crew/staff, allergies, etc.), type of accident or incident, geographic data (e.g., patient location, incident or accident location, etc.), priority evaluation based on type or severity of injuries, accident or incident related data (e.g., black box data such as speed at impact, time of accident, data to assist in diagnosis, etc.), etc. Moreover, the match component 102 can interact with the plurality of medical facilities 204 to be informed on characteristics or details associated therewith. For instance, information (e.g., characteristics, details, etc.) such as location, staffing, resources, medical staff specialties, transportation availability, transportation options, devices, equipment, patient flow (e.g., busy, calm, etc.), and/or any other data related to the medical facility 104. By evaluating the data related to the user 202 as well as information related to the plurality of medical facilities 204, the match component 102 can target the optimal medical facility to transport the user 202 in need of medical care.

For instance, a medical report can be received by the match component 102 informing of an emergency care situation for a patient, wherein the match component 102 can evaluate and identify criteria in which to select an urgent care facility (e.g., medical facility 104). The medical report can include data such as patient vitals, injuries, prognosis, remedies, and/or other requirements for treatment. Based on evaluating the medical report and having information or statistics related to available medical facilities 204, the match component 102 can employ a match by further analyzing traffic/transportation data (e.g., the report, traffic, traffic flow, assets, location, etc.). In regards to remote destination and uncertainty, the facility and directions to get to the medical facility can be identified by the system 200 as well as who is on site (e.g., vehicles, equipment, personnel that can sustain the patient to get them to the best location/facility). Thus, an optimal medical facility (e.g., including assets, devices, vehicles, etc.) and directions can be matched based on data particular to such emergency care situation. In a specific example, the match component 102 can examine a patient's location, a medical condition, traffic prediction, traffic flow, directions/routes, available medical equipment/personnel, and the like in order to identify an optimal medical facility for an emergency situation.

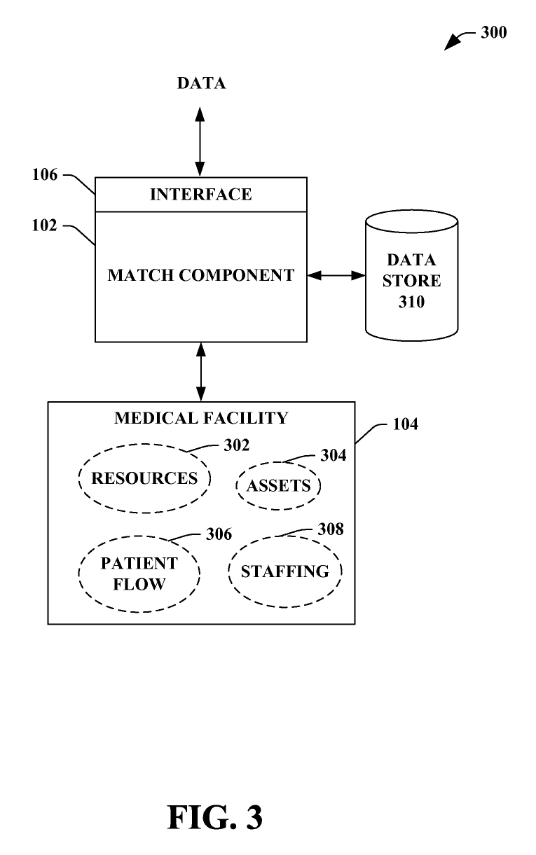

FIG. 3 illustrates a system 300 that facilitates transporting a patient in need of urgent medical care to a medical facility based on evaluating an injury of the patient and/or characteristics of the potential medical facilities. The match component 102 can pick a “best fit” medical facility 104 for a particular medical emergency or urgency situation related to a patient. Specifically, the match component 102 can collect data related to a patient or a medical emergency situation or incident and locate an optimal medical facility that can accommodate such patient in an efficient manner. For example, the location of a patient and a route to a potential medical facility (and associated traffic) can be a factor that the match component 102 takes into account. Thus, the system 300 can select medical facility B that is further away but a shorter route/drive than medical facility A for a patient based on traffic flow, predicted traffic, traffic updates, and the like.

As discussed, the match component 102 can analyze data related to at least one of a patient, an accident or incident, traffic, and/or a medical facility. In particular, the match component 102 can request, collect, and/or receive information related to the medical facility 104 in order to aid in optimally pairing a patient with a medical facility. The medical facility 104 can include information or details such as, but not limited to, resources 302, assets 304, patient flow 306 (e.g., amount of patients handled by the medical facility, maximum number of patients that can be handled/serviced, etc.), and/or staffing 308 (e.g., medical professionals, employee credentials, employee specialties, etc.). For instance, the match component 102 can take into account a medical facility's resources 302 such as, but not limited to, available experts, doctors, nurses, employees, operating rooms, medicine, devices, electronics, available hospital rooms, emergency transit operators, transportation vehicles, and the like. Furthermore, a medical facility's assets 304 such as devices in a vehicle/facility, drugs, equipment, needles, oxygen, scanning devices, medical equipment, bandages, inventory items, and the like can be evaluated by the match component 102.

The system 300 can further include a data store 310 that can include any suitable data related to a patient, an incident that requires medical assistance, an accident, a medical facility, traffic on a route between an accident and a medical facility, etc. It is to be appreciated that such information or data can be at least one of dynamically gathered, collected and periodically updated, and/or any suitable combination thereof. For example, a periodic update can be requested or retrieved from medical facilities based on duration of time. In general, the data store 310 can include, but not limited to including, patient data, accident or incident data, transportation/traffic data, medical facility information, and/or any suitable combination thereof. Specifically, the data store 310 can include patient location, patient status, urgency of medical needs, patient insurance coverage (e.g., whether or not the medical facility is within an insurance company network, etc.), patient preference, travel distance, routes from the patient location to the medical facility location, available medical resources, traffic predictions, traffic flow, traffic patterns, emergency vehicle patterns, previous traffic flows, databases of ambulance flows, medical facility assets (e.g., devices in a vehicle/facility, drugs, equipment, needles, oxygen, scanning devices, etc.), medical professional staffing (e.g., employees on staff, specialists, experts, surgeons, credentials of employees, etc.), patient status during transport, received medical data (e.g., EMT report, initial prognosis, blood pressure, vital stats, heart rate, historic medical data, etc.), history of traffic patterns, transportation availability (e.g., mode of transportation, drivers/operators available, etc.), transportation options, and/or any other suitable data associated with transporting a patient to a medical facility 104 in an emergency situation.

It is to be appreciated that the data store 310 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 310 of the subject systems and methods is intended to comprise, without being limited to, these and any other suitable types of memory. In addition, it is to be appreciated that the data store 310 can be a server, a database, a hard drive, a pen drive, an external hard drive, a portable hard drive, and the like.

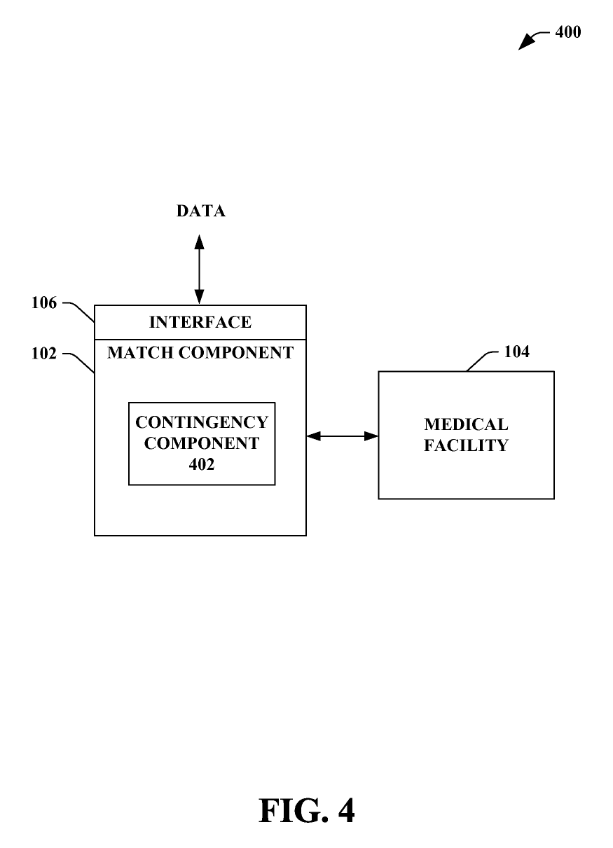

FIG. 4 illustrates a system 400 that facilitates identifying an optimal medical facility for a patient in need of emergency or urgent medical attention. The system 400 can employ a contingency component 402 that enables a pre-calculated or dynamically generated contingency plan for a patient being transported in an emergency situation. In general, the contingency component 402 can provide online adaptive flows based on real time monitoring of at least one of a patient, traffic, prediction of traffic, etc. to make decisions and updates based on information (e.g., stuck in traffic, construction, detours, etc.). In other words, the contingency component 402 can re-assess a transport for a patient based on a circumstance or event that may have been unexpected in a match initiated by the match component 108.

For instance, a first evaluation of transportation data can allow the match component 108 to identify a particular medical facility with a set of directions and/or routes, yet an unexpected event or situation can arise to which the contingency component 402 can re-evaluate and/or utilize a pre-defined plan to employ for transport. For example, the unexpected event or situation can be, but is not limited to, change in traffic, a traffic prediction correction (e.g., traffic heavier or lighter than predicted, etc.), road construction, machine malfunction (e.g., car trouble, etc.), device malfunction (e.g., medical facility with a certain device is malfunctioning, etc.), medical professional availability, change in patient vital signs, increase or decrease of severity of health condition, and/or any other suitable change in transportation data evaluated to select a medical facility to transport a patient. Based on unexpected event or situation, the contingency component 402 can implement a revised or pre-defined plan in which a match between a medical facility, directions, devices, medical professional availability, etc. and a patient can be ascertained. It is to be appreciated, as discussed, that the contingency component 402 can utilize pre-defined plans (e.g., user defined, medical protocol, plans based on severity of injury, plans based on traffic, machine-learning based plans, any suitable combination thereof, etc.) for events or generate such plans based on real time situations specific to the patient in transport.

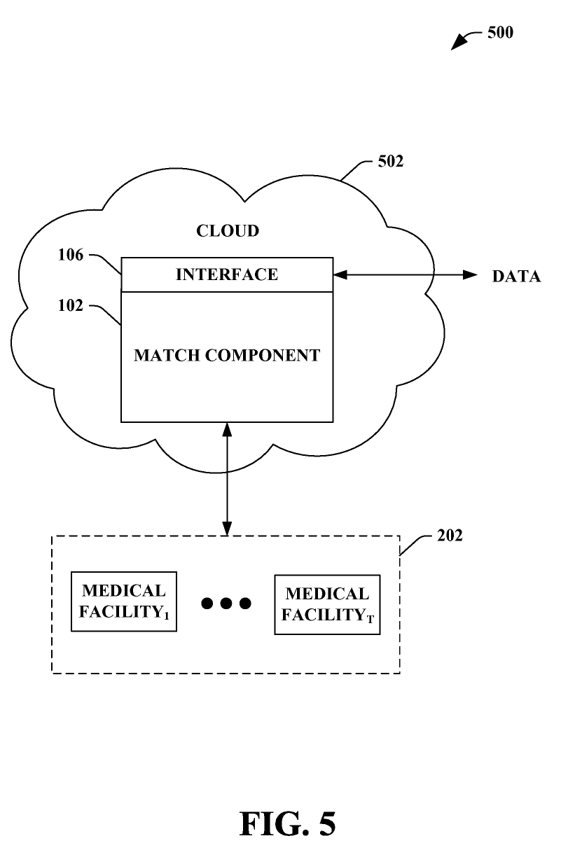

FIG. 5 illustrates a system 500 that facilities communicating with a plurality of medical facilities to assess an appropriate facility to transport an emergency medical incident. The system 500 can utilize a cloud 502 that can incorporate at least one of the match component 102, the interface 106, and/or any suitable combination thereof. It is to be appreciated that the cloud 502 can include any suitable component, device, hardware, and/or software associated with the subject innovation. The cloud 502 can refer to any collection of resources (e.g., hardware, software, combination thereof, etc.) that are maintained by a party (e.g., off-site, on-site, third party, etc.) and accessible by an identified user over a network (e.g., Internet, wireless, LAN, cellular, Wi-Fi, WAN, etc.). The cloud 502 is intended to include any service, network service, cloud service, collection of resources, etc. and can be accessed by an identified user or medical facility via a network. For instance, two or more users or medical facilities can access, join, and/or interact with the cloud 502 and, in turn, at least one of the match component 102, the interface 106, and/or any suitable combination thereof. In addition, the cloud 502 can provide any suitable number of service(s) to any suitable number of user(s) and/or client(s). In particular, the cloud 502 can include resources and/or services that enable at least one of 1) receipt of data related to an emergency medical incident and/or a medical facility; or 2) selection of a medical facility.

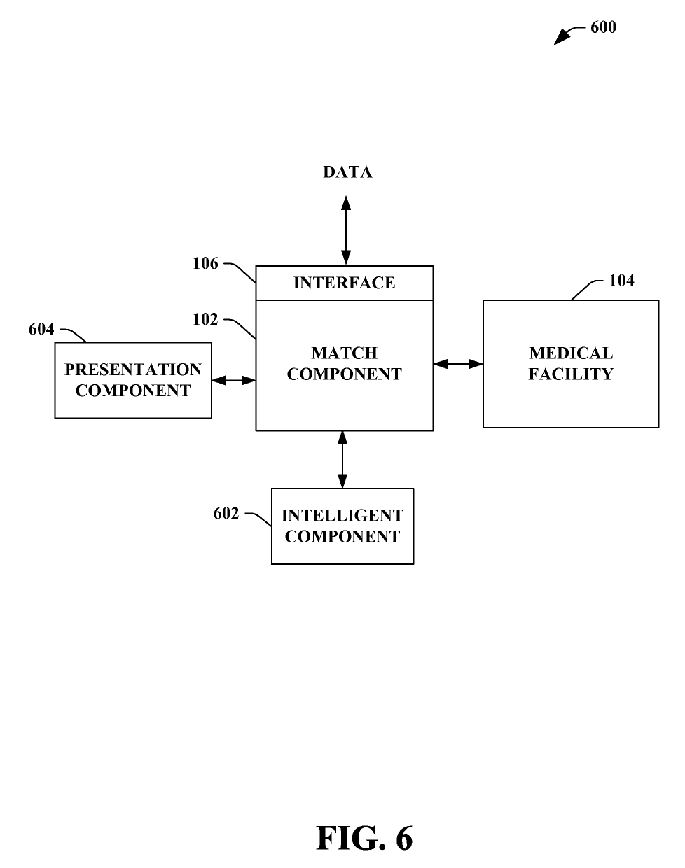

FIG. 6 illustrates a system 600 that employs intelligence to facilitate selection of a medical facility to receive an emergency incident. The system 600 can include the match component 102, the medical facility 104, and the interface 106. It is to be appreciated that the match component 102, the medical facility 104, and/or the interface 106 can be substantially similar to respective components, facilities, and interfaces described in previous figures. The system 600 further includes an intelligent component 602. The intelligent component 602 can be utilized by the match component 102 to facilitate selecting a “best fit” or optimal medical facility for a patient in need of urgent or emergency medical care. For example, the intelligent component 602 can infer patient preferences for selection of a medical facility, traffic, routes to a medical facility, medical facility to select for a patient, a transportation mode, a real-time adjustment to a route to a medical facility, a contingency plan adjustment, estimated travel time for a patient to arrive at a medical facility, patient flow for a medical facility, emergency traffic flow, optimal transportation mode, etc.

The intelligent component 602 can employ value of information (VOI) computation in order to identify a medical facility for a particular patient in need of emergency or urgent medical attention. For instance, by utilizing VOI computation, the most ideal and/or appropriate medical facility for a patient can be determined. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The match component 102 can further utilize a presentation component 604 that provides various types of user interfaces to facilitate interaction between a user and any component coupled to the match component 102. As depicted, the presentation component 604 is a separate entity that can be utilized with the match component 102. However, it is to be appreciated that the presentation component 604 and/or similar view components can be incorporated into the match component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the match component 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

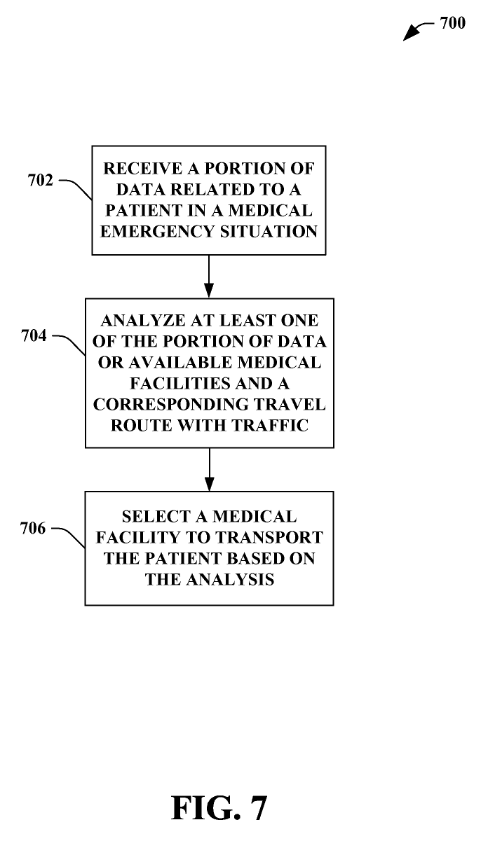

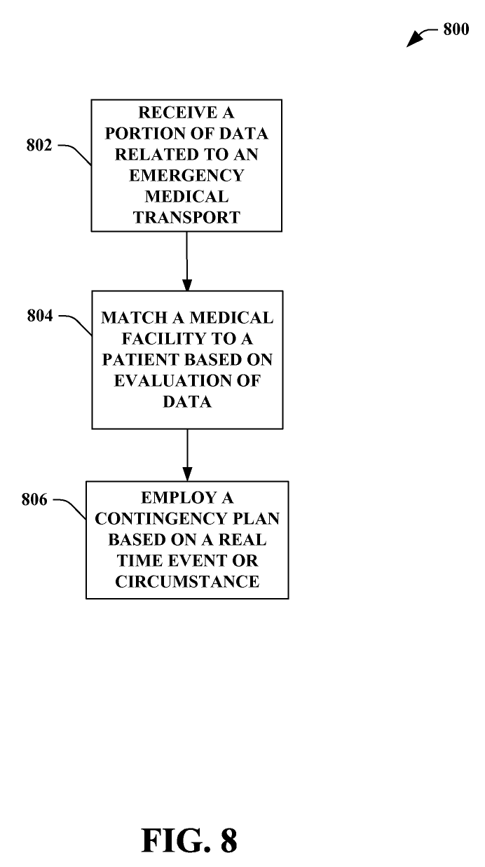

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates identifying a medical facility to transport an emergency situation based on travel distance and/or traffic. At reference numeral 702, a portion of data related to a patient in a medical emergency or urgent situation can be received. In particular, the portion of data can include a patient status (e.g., injuries, vitals, medical needs, health insurance coverage, patient preference, etc.), a location of the patient, and the like. In one example, the portion of data related to the patient can be dynamically received upon medical transport arriving to a scene of the incident or accident. Thus, upon arrival, assessment of the patient can be seamlessly communicated or transmitted including medical needs (e.g., medicine, devices, equipment, surgeons, specialists, etc.) and injuries sustained.

At reference numeral 704, at least one of the patient data or available medical facility and a corresponding travel route with traffic can be analyzed. The potential or available medical facilities (e.g., within a reasonable travel distance or facilities who have opted to be available to receive patients) can be evaluated as well as a route and traffic related thereto. In other words, a medical facility can be analyzed in order to ascertain whether or not the patient can be handled or serviced appropriately and adequately. Moreover, travel time can be analyzed based on predicting traffic along the route from the patient's location to the medical facility's location. For instance, characteristics such as personnel, staffing, assets (e.g., devices in a vehicle/facility, drugs, equipment, needles, oxygen, scanning devices, etc.), resources, patient flow, modes of transportation, and the like can be considered in determining if a medical facility suites a particular patient. At reference numeral 706, a medical facility can be selected to transport the patient based on the analysis. In general, based on evaluating or analyzing at least one of patient data, traffic data related to a route from a patient location to a medical facility location, and/or medical facility data, an optimal match between a patient and a medical facility is generated.

FIG. 8 illustrates a method 800 for generating a contingency plan for a real time event or circumstance that occurs during transport of an emergency medical incident. At reference numeral 802, a portion of data related to an emergency medical transport can be received. For example, the portion of data can be associated with the patient involved in the emergency incident or accident, the accident or incident, a potential medical facility, a transportation mode, a location of the patient, a location of a medical facility, traffic, predicted traffic, routes, etc.

At reference numeral 804, a medical facility can be matched to a patient based on evaluation of the portion of data. For example, an emergency call can be received in which information gained can be evaluated in order to identify or select an optimal medical facility to transport the patient. It is to be appreciated that various factors such as injuries, urgency, location, traffic, resources, assets, patient flow, staffing, patient preferences, etc. can be considered when choosing a medical facility. In addition, a best match can be made in relation to a transportation, presence and availability, by evaluating portions of transportation data such as estimations of time of arrival, availability of resources, presence of medical professionals, etc.

At reference numeral 806, a contingency plan can be employed based on a real time event or circumstance associated with the medical emergency or incident. In general, online adaptive flows can be utilized based on real time monitoring of at least one of a patient, traffic, prediction of traffic, etc. in order to make decisions and updates based on information (e.g., stuck in traffic, construction, detours, etc.). In other words, a patient transport can be re-assessed based on a circumstance or event that may have been unexpected in a match initiated. For example, the unexpected event or situation can be, but is not limited to, change in traffic, a traffic prediction correction (e.g., traffic heavier or lighter than predicted, etc.), road construction, machine malfunction (e.g., car trouble, etc.), device malfunction (e.g., medical facility with a certain device is malfunctioning, etc.), medical professional availability, change in patient vital signs, increase or decrease of severity of health condition, etc.

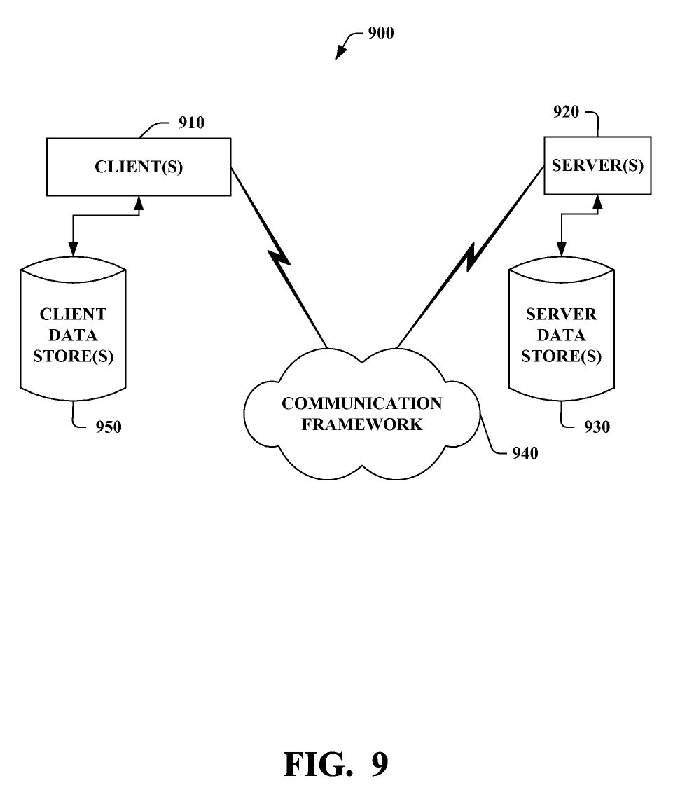

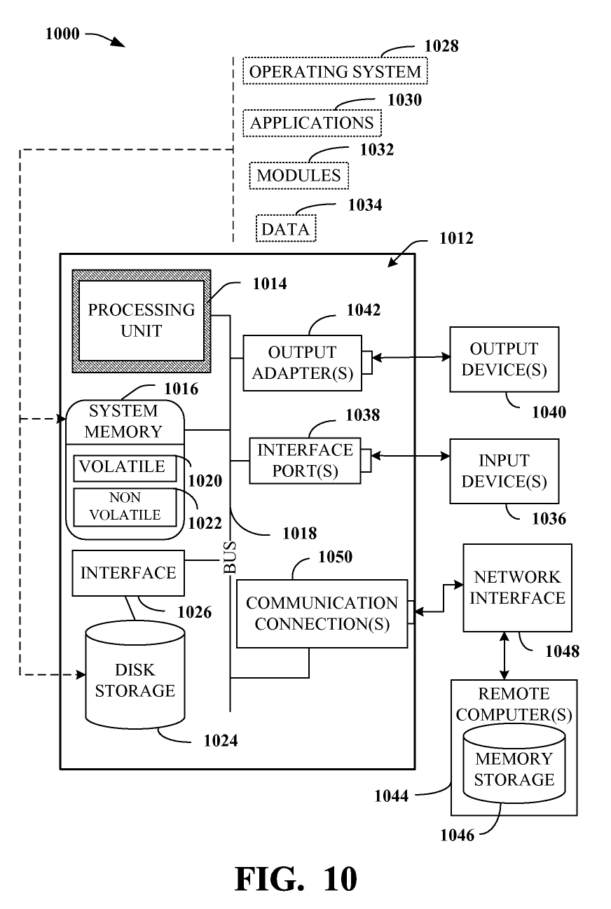

In order to provide additional context for implementing various aspects of the claimed subject matter, FIGS. 9-10 and the following discussion is intended to provide a brief, general description of a suitable computing environment in which the various aspects of the subject innovation may be implemented. For example, a match component that facilitates selecting a medical facility to transport a patient in need of urgent medical attention based on travel distance and predicted traffic, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. It is to be appreciated that the computer 1012 can be utilized in connection with a smartphone, PDA, PMP, and/or any other electronic device with enough computing power and connectivity to implement the subject innovation. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, medical devices, fitness devices, blood pressure monitor, blood glucose monitor, peak flow meter, devices to measure vitals, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), Body Area Network (BAN), Personal Area Network (PAN), and/or any other network utilized with sensors connected to monitor a person (e.g., health monitoring sensors embedded in clothing or apparel, body sensors that collect and/or store vital measurements continuously, heart rate monitoring, ECG monitoring, monitoring of blood glucose, under-skin implant sensors, etc.). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates identifying a medical facility for an emergency medical situation, comprising:
an interface that receives a portion of data related to an emergency medical incident and a corresponding location; and
a match component that evaluates the portion of data to select a medical facility in which to transport a patient involved in the emergency medical incident, the medical facility is ascertained based on a distance between the location of the emergency medical incident and a location for the selected medical facility and traffic related to a route there between.

2. The system of claim 1, the match component evaluates at least one of medical facility data, patient data, or traffic data.

3. The system of claim 2, the patient data is at least one of a patient status during transport, a severity of a patient injury, a location of a patient, a location of the emergency situation, a portion of patient medical data, a type of accident or incident, incident related data associated with a black box that collects accident information, a portion of geographic data, or a set priority based on type or severity of an injury.

4. The system of claim 2, the patient data is at least one of an emergency medical transport (EMT) report, an initial prognosis of a patient, a vital stat, a portion of historic medical data, a medical evaluation data from an on-site emergency medical crew, a patient insurance coverage, a route directing the patient to the medical facility location, patient authorized medical data, a genomic profile, a portion of authorized data from a relevant relative in a genealogy tree, or a patient preference.

5. The system of claim 2, the match component gathers the medical facility data dynamically based on a received emergency incident.

6. The system of claim 2, the match component gathers the medical facility data and implements updates based on duration of time.

7. The system of claim 2, the medical facility data is at least one of a route from the patient location to the medical facility location, a medical facility asset, a device in a vehicle, a device in the medical facility, a portion of medicine, a portion of a drug, a piece of equipment, medical professional staffing, an amount of employees on staff, an available specialist, an available expert, a staffed surgeon, a set of credentials of an medical facility employee, an available transportation mode, a medical facility location, a medical facility resource, a medical facility patient flow, an amount of doctors, an amount of nurses, an amount of available operating rooms, an amount of available hospital rooms, an amount of emergency transit operators, or an amount of inventory items related to the medical facility.

8. The system of claim 2, the traffic data is at least one of a traffic pattern, a previous traffic flow, a database of an ambulance flow, a portion of traffic pattern history, an emergency vehicle route, a set of directions, a travel distance, a route from a patient location to a medical facility location, a traffic prediction, or a real time traffic flow.

9. The system of claim 1, further comprising a contingency component that employs a contingency plan for the patient being transported based on an unexpected event during the transport.

10. The system of claim 9, the contingency plan is at least one of a pre-calculated plan, a dynamically generated plan, or a combination of a pre-calculated plan and a dynamically generated plan.

11. The system of claim 9, the contingency component utilizes an online adaptive flow based on real time monitoring of at least one of a patient, a portion of traffic, or a prediction of traffic in order to update the selection of the match component.

12. The system of claim 9, the unexpected event is at least one of a change in traffic, a traffic prediction correction a portion of road construction, a machine malfunction, a device malfunction, a medical professional availability, a change in a vital sign for the patient, an increase of severity of a health condition, or a decrease of severity of a health condition.

13. The system of claim 1, further comprising a cloud that incorporates at least one of the interface or the match component, the cloud is a collection of resources maintained by a party and accessible by at least one of an identified user, an identified patient, or an identified medical facility, over a network.

14. The system of claim 13, the cloud allows collected information to be private and secure utilizing a security technique.

15. The system of claim 1, the match component provides at least one of the following:
a selected portion of medical care to transport to the patient based on the evaluation of the portion of data;
a selected set of directions to direct the patient to a portion of medical care based on the evaluation of the portion of data;
a selected professional in which to refer the patient based on the evaluation of the portion of data; or
an identified expert in a specialty field that can provide a portion of treat the patient based on the evaluation of the portion of data.

16. A computer-implemented method that facilitates pairing a patient in need of emergency medical care with a medical facility, comprising:
receiving a portion of data related to a patient in a medical emergency situation;
analyzing at least one of the portion of medical data or an available medical facility and corresponding traffic route with traffic; and
selecting a medical facility to transport the patient based on the analysis.

17. The method of claim 16, further comprising employing a contingency plan based on at least one of an unexpected real time event or circumstance that occurs during a medical transport of the patient to the selected medical facility.

18. The method of claim 17, the contingency plan utilizes an online adaptive flow based on real time monitoring of at least one of a patient, a portion of traffic, or a prediction of traffic in order to update the selection of the medical facility.

19. The method of claim 17, the unexpected event is at least one of a change in traffic, a traffic prediction correction a portion of road construction, a machine malfunction, a device malfunction, a medical professional availability, a change in a vital sign for the patient, an increase of severity of a health condition, or a decrease of severity of a health condition.

20. A computer-implemented system that facilitates identifying a medical facility for an emergency medical situation, comprising:
means for receiving a portion of data related to an emergency medical incident and a corresponding location;
means for evaluating the portion of data to select a medical facility in which to transport a patient involved in the emergency medical incident; and
means for ascertaining the medical facility based on a distance between the location of the emergency medical incident and a location for the selected medical facility and traffic related to a route there between.
